(19) United States
(12) Patent Application Publication
(10) Pub. No.: US 2014/0182543 A1
(43) Pub. Date: Jul. 3, 2014

(54) FUEL SUPPLY SYSTEM FOR GASOLINE DIRECT INJECTION ENGINE

(71) Applicant: Hyundai Motor Company, Seoul (KR)

(72) Inventor: Woo Hee KWAK, Anyang-si (KR)

(73) Assignee: Hyundai Motor Company, Seoul (KR)

(21) Appl. No.: 13/952,346

(22) Filed: Jul. 26, 2013

(30) Foreign Application Priority Data
Dec. 28, 2012 (KR) 10-2012-0156434

(51) Int. Cl. F02M 63/02

(52) U.S. Cl. CPC F02M 63/0225
USPC 123/294

(57) ABSTRACT

A fuel supply system for a gasoline direct injection (GDI) engine may reduce noise caused by a high pulsation pressure generated in a high-pressure pump due to fuel pressure control. The fuel supply system may include: a high-pressure pump; a high-pressure rail; an injector that is installed at the high-pressure rail and injects a fuel into a combustion chamber of the GDI engine; and a high-pressure pipe that is connected between the high-pressure pump and the high-pressure rail so as to supply the fuel to the high-pressure rail, wherein a porous member for reducing a pulsation pressure through which a plurality of through holes through which the fuel to be supplied to the high-pressure rail passes, is formed, is installed on a flow passage of the high-pressure pipe.

CROSS-REFERENCE TO RELATED PATENT APPLICATION

The present application claims priority of Korean Patent Application Number 10-2012-0156434 filed Dec. 28, 2012, the entire contents of which application is incorporated herein for all purposes by this reference.

### BACKGROUND OF INVENTION

1. Field of Invention

The present invention relates to a fuel supply system for a gasoline direct injection (GDI) engine, and more particularly, to a fuel supply system for a GDI engine that may reduce noise caused by a high pulsation pressure generated in a high-pressure pump due to fuel pressure control.

2. Description of Related Art

In general, a gasoline direct injection (GDI) engine is a gasoline engine that injects a fuel directly into a combustion chamber. In the GDI engine, the pressure of the fuel that is supplied by a low-pressure pump from a fuel tank is increased using a high-pressure pump and is supplied to an injector so as to inject a high-pressure fuel directly into the combustion chamber.

FIG. 1 is a schematic view of a fuel supply system for a car in which the GDI engine is used. As illustrated in FIG. 1, the fuel supply system for the GDI engine includes a low-pressure system and a high-pressure system.

The low-pressure system includes a low-pressure pump 10 and a fuel pump relay 11, and the low-pressure pump 10 is located in the fuel tank and sends the fuel to a high-pressure pump 20 via a low-pressure pump line 12.

The instant a driver starts the GDI engine in the low-pressure system, a controller 40 drives the low-pressure pump 10 by operating the fuel pump relay 11. Thus, the fuel in the fuel tank is sent to the high-pressure pump 20 by the low-pressure pump 10.

The high-pressure system includes the high-pressure pump 20, a high-pressure regulating valve 21, a pressure sensor, and an injector 25. The high-pressure pump 20 is connected to a cam shaft of the GDI engine and pressurizes the fuel supplied from the low-pressure system, thereby increasing the pressure of the fuel to a pressure suitable for engine load and supplying the fuel.

The high-pressure pump 20 of the high-pressure system is connected to a high-pressure rail 23 in which the injector 25 is installed, via a high-pressure pipe 22. Thus, when a high-pressure fuel of which pressure is increased by the high-pressure pump 20 flows into the high-pressure rail 23 via the high-pressure pipe 22, the injector 25 injects the high-pressure fuel directly into the combustion chamber.

In this case, the controller 40 controls high-pressure fuel constitution and fuel injection by using the injector 25.

As the GDI engine has been developed, fuel efficiency is improved, output of the GDI engine is improved, and the amount of an exhaust gas is reduced. However, due to the high-pressure fuel, noise occurs between the high-pressure pump 20 and the injector 25.

In particular, as a high-pressure regulating valve (a solenoid valve) 21 is open or closed so as to control the fuel pressure of the high-pressure pump 20 of the high-pressure system, a high pulsation pressure is generated at an outlet of the high-pressure pump 20. Due to the high pulsation pressure, noise occurs in a downstream side of a rear end of the high-pressure pump 20, i.e., in the high-pressure pipe 22.

FIG. 2 is a cross-sectional view of the high-pressure pump 20 of the fuel supply system for the GDI engine of FIG. 1. The fuel that flows into the high-pressure rail 23 via the high-pressure adjusting valve (a solenoid valve) 21 is compressed in the high-pressure pump 20 due to a reciprocating motion of a position 26 driven by a cam, and the fuel compressed at the high pressure is discharged from a pump outlet 27.

In this case, a high pulsation pressure is generated in the pump outlet 27.

According to the related art, absorption and insulation materials are used in the high-pressure pipe 23 and the high-pressure rail 23 so as to reduce noise. However, noise is radiated from the high-pressure rail 23 and the GDI engine.

The information disclosed in this Background section is only for enhancement of understanding of the general background of the invention and should not be taken as an acknowledgement or any form of suggestion that this information forms the prior art already known to a person skilled in the art.

### BRIEF SUMMARY

The present invention provides a fuel supply system for a gasoline direct injection (GDI) engine that may reduce noise caused by a high pulsation pressure generated in a high-pressure pump due to fuel pressure control.

According to an aspect of the present invention, there is provided a fuel supply system for a gasoline direct injection (GDI) engine, including: a high-pressure pump; a high-pressure rail; an injector that is installed at the high-pressure rail and injects a fuel into a combustion chamber of the GDI engine; and a high-pressure pipe that is connected between the high-pressure pump and the high-pressure rail so as to supply the fuel to the high-pressure rail, wherein a porous member for reducing a pulsation pressure through which a plurality of through holes through which the fuel to be supplied to the high-pressure rail passes, is formed, is installed on a flow passage of the high-pressure pipe.

The porous member may be installed in a housing connected to a midway point of a pipeline of the high-pressure pipe.

The high-pressure pump may include an upstream pipe connected to an outlet of the high-pressure pump and a downstream pipe connected to an inlet of the high-pressure rail, and the housing may be connected between the upstream pipe and the downstream pipe so that the fuel passes through the upstream pipe and the downstream pipe.

The plurality of through holes of the porous member may be formed so that a sum of flow passage cross-sectional areas of the whole through holes is greater than a flow pass cross-sectional area of the high-pressure pipe.

The through holes of the porous member may be formed so that a sum of flow passage cross-sectional areas of the whole through holes is greater than a cross-sectional area of the inlet of the high-pressure rail to which the high-pressure pipe is connected.

The through holes of the porous member may be formed so that a sum of flow passage cross-sectional areas of the whole through holes is greater than a cross-sectional area of the outlet of the high-pressure pump to which the high-pressure pipe is connected.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view of a structure of a fuel supply system for a gasoline direct injection (GDI) engine according to the related art;

FIG. 2 is a cross-sectional view of a high-pressure pump of the fuel supply system for the GDI engine illustrated in FIG. 1, so as to explain problems of the related art;

FIG. 3 is a perspective view of an exemplary fuel supply system for a GDI engine according to the present invention;

FIG. 4 is a cross-sectional view illustrating a state where a pulsation-pressure reducing portion is installed at a high-pressure pipe of the fuel supply system illustrated in FIG. 3;

FIG. 5 is a perspective view of a porous member of the pulsation-pressure reducing portion of the fuel supply system of FIG. 3; and

FIGS. 6 and 7 are views of noise measurement data indicating that a noise reduction effect is shown in the GDI engine to which an exemplary fuel supply system according to the present invention is applied.

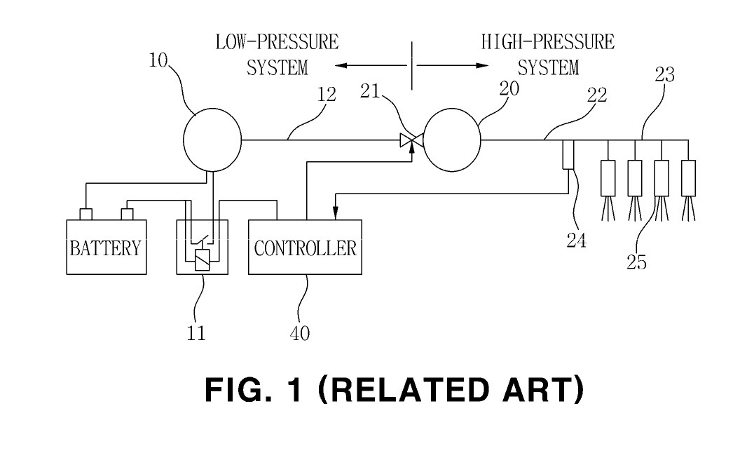

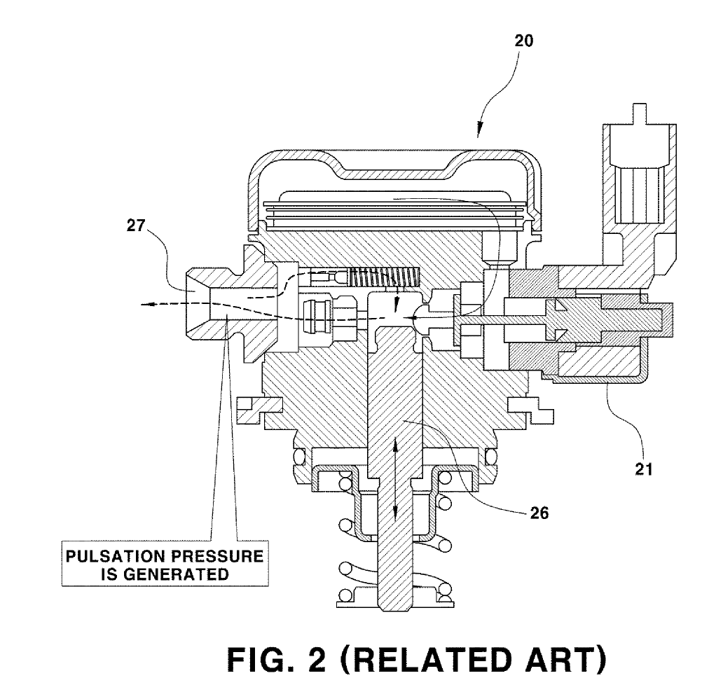

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention relates to a fuel supply system for a gasoline direct injection (GDI) engine, and more particularly, to a fuel supply system for a GDI engine that may reduce a high pulsation pressure generated in a high-pressure pump due to a valve opening/closing operation when a fuel pressure is controlled by performing an opening/closing operation of a high-pressure regulating valve (a solenoid valve) and may reduce pulsation noise caused by the high pulsation pressure.

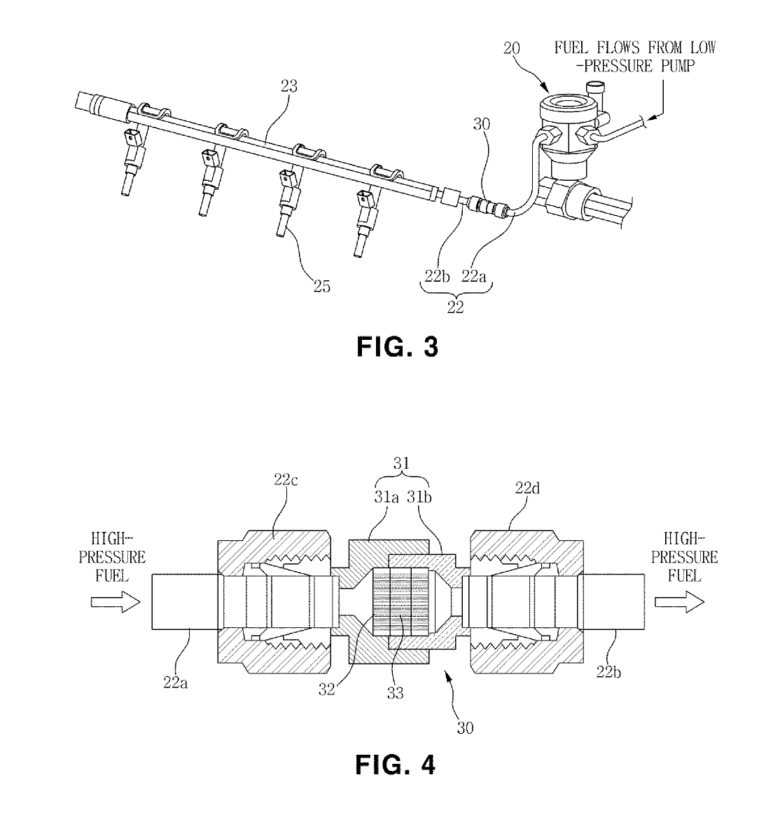

FIG. 3 is a perspective view of a fuel supply system for a GDI engine according to various embodiments of the present invention. As illustrated in FIG. 3, a pulsation-pressure reducing portion 30 including a porous member embedded therein is installed at a high-pressure pipe 22 connected to an outlet of a high-pressure pump 20.

The pulsation-pressure reducing portion 30 is an element for reducing a fuel pulsation pressure generated in the high-pressure pump 20 and noise caused by the fuel pulsation pressure. The pulsation-pressure reducing portion 30 is installed at a downstream side of a rear end of the high-pressure pump 20, i.e., at a midway point in the high-pressure pump 22 connected to the outlet of the high-pressure pump 20.

The pulsation-pressure reducing portion 30 is installed on a pipeline of the high-pressure pipe 22. The high-pressure pipe 22 is divided into two pipes 22a and 22b that are connected to the outlet of the high-pressure pump 20 and an inlet of a high-pressure rail 23, respectively, and then, the pulsation-pressure reducing portion 30 is connected between two pipes 22a and 22b and allows the high-pressure fuel to pass through two pipes 22a and 22b.

Hereinafter, in the present specification, for clarity, a high-pressure pipe 22a connected to the outlet of the high-pressure pump 20 based on the pulsation-pressure reducing portion 30 is referred to as an upstream pipe, and a high-pressure pipe 22b connected to the inlet of the high-pressure rail 23 based on the pulsation-pressure reducing portion 30 is referred to as a downstream pipe.

The upstream pipe 22a and the downstream pipe 22b are connected to each other via the pulsation-pressure reducing portion 30 and constitute one pipeline. The pipeline constitutes one high-pressure pipe 22 for supplying the high-pressure fuel that is forcibly sent by the high-pressure pump 20, to the high-pressure rail 23, like in the related art.

In the above configuration, the pulsation-pressure reducing portion 30 is connected between the upstream pipe 22a and the downstream pipe 22b and constitutes a pipeline through which the high-pressure fuel passes, thereby reducing a pulsation pressure and noise.

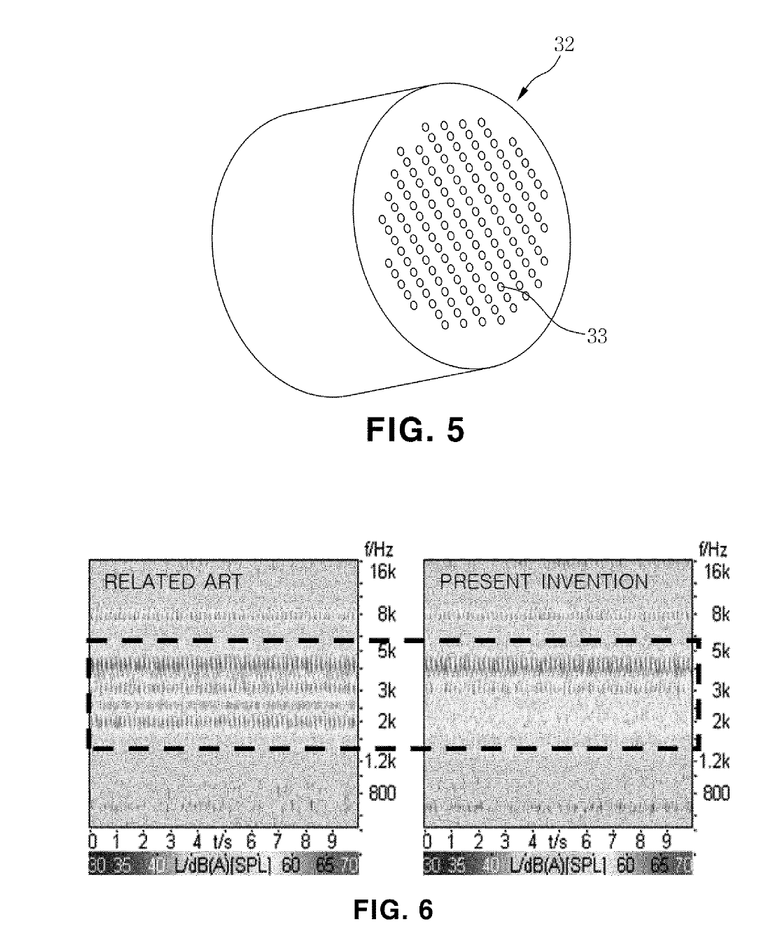

FIG. 4 is a cross-sectional view illustrating a state where the pulsation-pressure reducing portion 30 is installed at the high-pressure pipe 20 of the fuel supply system illustrated in FIG. 3, and FIG. 5 is a perspective view of a porous member of the pulsation-pressure reducing portion 30 of the fuel supply system of FIG. 3.

As illustrated in FIGS. 4 and 5, the pulsation-pressure reducing portion 30 includes a housing 31 (including female and male housings 31a and 31b) that is combined with each of ends of connection parts of the upstream pipe 22a and the downstream pipe 22b. A porous member 32 for reducing a pulsation pressure through which a plurality of through holes 33 is formed in a thickness direction when the female and male housings 31a and 31b respectively installed at two pipes 22a and 22b are combined with each other, is embedded in the housing 31.

Here, the pipes 22a and 22b and the housings 31a and 31b are combined to each other in such a way that the housings 31a and 31b are screw-coupled to nut members 22c and 22d installed at ends of connection parts of the pipes 22a and 22b and the housings 31a and 31b are combined with each other by using forcible insertion or screw coupling.

Also, the plurality of through holes 33 of the porous member 32 are holes through which the fuel passes. The diameter of each through hole 33 and the length of each through hole 33 (that is a thickness of the porous member 32) may be optimized and set according to characteristics of the GDI engine so as to reduce the pulsation pressure.

The through holes 33 of the porous member 32 may be holes having a circular cross-section shape, i.e., circular holes, or holes having a hexagonal cross-section shape.

Also, the porous member 32 may be inserted in the housings 31a and 31b by forcible insertion and may be fixed thereto.

In addition, in order to guarantee a sufficient flow of the fuel supplied to the high-pressure rail 23 through the high-pressure pipe 22, the porous member 32 may have an extension type structure in which the cross-sectional area of the whole flow passage of the porous member 32 with respect to the pulsation-pressure reducing portion 30 is greater than the cross-sectional area of flow passages of the high-pressure pipes 22a and 22b.

That is, the sum of flow passage cross-sectional areas of the whole through holes 33 formed in the porous member 32 may be greater than the flow passage cross-sectional area of the high-pressure pipes 22a and 22b through which the fuel flows. In this way, the porous member 32 manufactured in such a way that the sum of flow passage cross-sectional areas of the whole through holes 33 is greater than the flow pass cross-sectional area of the high-pressure pipes 22a and 22b, is inserted in the housing 31 and is fixed thereto such that the pulsation-pressure reducing portion 30 can be configured.

In this case, in order to have a pulsation-pressure reducing effect, the sum of flow passage cross-sectional areas of the whole through holes 33 of the porous member 32 needs to be greater than the cross-sectional area of the output of the high-pressure pump 20 to which the high-pressure pipe 22a is connected. Also, the cross-sectional area of the inlet of the high-pressure rail 23 to which the high-pressure pipe 22b is connected, needs to be large.

The pulsation-pressure reducing portion 30 may reduce a high pulsation pressure when the high pulsation pressure is absorbed by the through holes 33 of the porous member 32, and due to a reduction in the pulsation pressure, noise may be reduced.

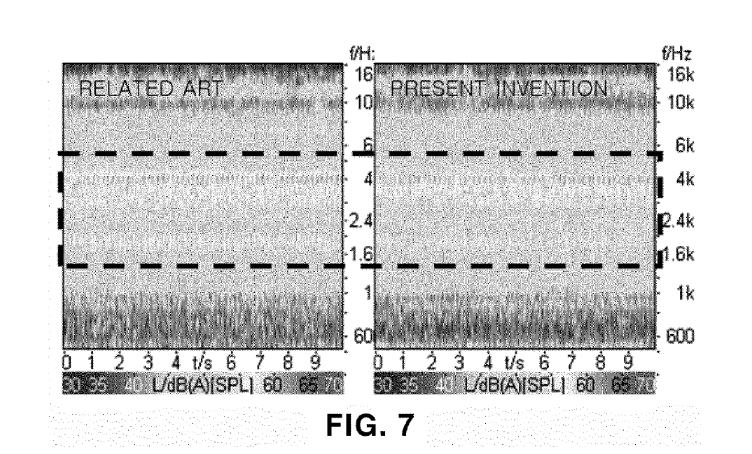

FIGS. 6 and 7 are views of noise measurement data indicating that a noise reduction effect is shown in the GDI engine to which a fuel supply system according to the present invention is applied, which illustrate data obtained by evaluating a pulsation-pressure reducing effect of a high-pressure pump.

FIG. 6 shows data obtained by measuring radiation noise in a lateral direction of the GDI engine to which the fuel supply system including the above-described pulsation-pressure reducing portion is applied, and FIG. 7 shows data obtained by measuring radiation noise in an upward direction of the GDI engine.

As a result of applying the fuel supply system according to the present invention, measurement data of radiation noise in the lateral direction of the GDI engine in an engine idle condition shows a noise reducing effect of 1.5 dBA in a frequency band of 1.5 to 5 kHz, as illustrated in FIG. 6, and measurement data of radiation noise in the upward direction of the GDI engine shows a noise reducing effect of 0.6 dBA in the frequency band of 1.5 to 5 kHz, as illustrated in FIG. 7.

In this way, when the fuel supply system according to the present invention is used, a pulsation pressure can be reduced by the pulsation-pressure reducing portion having the porous member embedded therein, and noise caused by the pulsation pressure can be reduced.

As described above, in a fuel supply system for a GDI engine according the present invention, a porous member for reducing a pulsation pressure through which a plurality of through holes is formed, is installed on a flow passage of a high-pressure pipe that is connected between a high-pressure pump and a high-pressure rail so as to supply a fuel to the high-pressure rail. Thus, a high pulsation pressure is absorbed by the porous member and thus can be reduced, and due to a reduction in the pulsation pressure, noise can be reduced.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fuel supply system for a gasoline direct injection (GDI) engine comprising:
a high-pressure pump;
a high-pressure rail;
an injector that injects a fuel from the high-pressure rail into a combustion chamber of the GDI engine; and
a high-pressure pipeline that is connected between the high-pressure pump and the high-pressure rail so as to supply the fuel to the high-pressure rail;
wherein a porous member for reducing a pulsation pressure is installed on a flow passage of the high-pressure pipeline, wherein the porous member includes a plurality of through holes through which the fuel to be supplied to the high-pressure rail passes.

2. The fuel supply system of claim 1, wherein the porous member is installed in a housing connected to a midway point of the pipeline of the high-pressure pipeline.

3. The fuel supply system of claim 2, wherein the high-pressure pump comprises an upstream pipe connected to an outlet of the high-pressure pump and a downstream pipe connected to an inlet of the high-pressure rail, and the housing is connected between the upstream pipe and the downstream pipe so that the fuel passes through the upstream pipe and the downstream pipe.

4. The fuel supply system of claim 1, wherein the plurality of through holes of the porous member is formed so that a sum of flow passage cross-sectional areas of the whole through holes is greater than a flow pass cross-sectional area of the high-pressure pipeline.

5. The fuel supply system of claim 1, wherein the through holes of the porous member are formed so that a sum of flow passage cross-sectional areas of the whole through holes is greater than a cross-sectional area of the inlet of the high-pressure rail to which the high-pressure pipeline is connected.

6. The fuel supply system of claim 2, wherein the through holes of the porous member are formed so that a sum of flow passage cross-sectional areas of the whole through holes is greater than a cross-sectional area of the inlet of the high-pressure rail to which the high-pressure pipeline is connected.

7. The fuel supply system of claim 3, wherein the through holes of the porous member are formed so that a sum of flow passage cross-sectional areas of the whole through holes is greater than a cross-sectional area of the inlet of the high-pressure rail to which the high-pressure pipeline is connected.

8. The fuel supply system of claim 4, wherein the through holes of the porous member are formed so that a sum of flow passage cross-sectional areas of the whole through holes is greater than a cross-sectional area of the inlet of the high-pressure rail to which the high-pressure pipeline is connected.

9. The fuel supply system of claim 1, wherein the through holes of the porous member are formed so that a sum of flow passage cross-sectional areas of the whole through holes is greater than a cross-sectional area of the outlet of the high-pressure pump to which the high-pressure pipeline is connected.

10. The fuel supply system of claim 2, wherein the through holes of the porous member are formed so that a sum of flow passage cross-sectional areas of the whole through holes is greater than a cross-sectional area of the outlet of the high-pressure pump to which the high-pressure pipeline is connected.

11. The fuel supply system of claim 3, wherein the through holes of the porous member are formed so that a sum of flow passage cross-sectional areas of the whole through holes is greater than a cross-sectional area of the outlet of the high-pressure pump to which the high-pressure pipeline is connected.

12. The fuel supply system of claim 4, wherein the through holes of the porous member are formed so that a sum of flow passage cross-sectional areas of the whole through holes is greater than a cross-sectional area of the outlet of the high-pressure pump to which the high-pressure pipeline is connected.
